(19) United States
(12) Patent Application Publication
(10) Pub. No.: US 2023/0153376 A1
(43) Pub. Date: May 18, 2023

(54) OPTIMIZATION METHOD, INFORMATION PROCESSING DEVICE, AND INFORMATION PROCESSING SYSTEM

(71) Applicant: Hitachi, Ltd., Tokyo (JP)

(72) Inventors: Yusuke SUGITA, Tokyo (JP); Takuya OKUYAMA, Tokyo (JP)

(21) Appl. No.: 17/895,250

(22) Filed: Aug. 25, 2022

(30) Foreign Application Priority Data
Nov. 16, 2021 (JP) 2021-186554

(51) Int. Cl. G06F 17/18

(52) U.S. Cl. CPC G06F 17/18

(57) ABSTRACT

Provided are an optimization method, an information processing device, and an information processing system capable of efficiently performing a ground state search of a constrained binary quadratic model. The information processing device performs the ground state search for the constrained binary quadratic model by substituting the ground state search for the binary quadratic model in which the interaction relationship between variables has a complete bipartite graph structure. Here, this information processing device divides the variable group corresponding to the vertex set divided into two in the complete bipartite graph into a group capable of updating the state in which the constraint is satisfied. Then, this information processing device can update the group of each variable group in parallel based on the information of the energy function and the variable, and execute the process of searching the ground state.

### CROSS-REFERENCE TO RELATED APPLICATION

The present application claims priority from Japanese application JP 2021-186554, filed on Nov. 16, 2021, the contents of which is hereby incorporated by reference into this application.

### BACKGROUND OF THE INVENTION

### 1. Field of the Invention

The present invention relates to an optimization method, an information processing device, and an information processing system.

### 2. Description of the Related Art

In Patent Document (WO2019216277A1), it describes a method for efficiently performing unconstrained binary quadratic optimization based on simulated annealing by converting the interaction relation of the Ising model having a quadratic energy function into a complete bipartite graph structure.

Non-Patent Document (F. Glover, G. Kochenberger, and Y. Du, “A Tutorial on Formulating and Using QUBO Models”, preprint (arXiv:1811.11538).) describes a method for converting various combinatorial optimization problems into binary quadratic optimization problems.

Many physical and social phenomena can be expressed by interaction models. The interaction model is defined by a plurality of nodes constituting the model, an interaction between the nodes, and a bias for each node. Various models have been proposed in the fields of physics and social science, and many of them can be interpreted as a form of interaction model.

As a typical example of the interaction models, there is the Ising model or a binary quadratic model equivalent thereto (hereinafter referred to as BQM). BQM has a binary value such as 0/1 for each node, and has an energy function expressed by a quadratic expression based on the interaction between the nodes and the bias for each node. The search for the lowest energy state (called the ground state) of BQM is equivalent to an unconstrained binary quadratic optimization problem. As a method for searching this ground state, there is a Markov chain Monte Carlo method. The Markov chain Monte Carlo method is a calculation method for estimating a desired statistic by sampling states of variables while probabilistically updating the state.

Many of the actual combinatorial optimization problems have not only an evaluation function that indicates the quality of the solution, but also constraints that the solution must satisfy. When the combinatorial optimization problem is converted into a binary quadratic optimization problem, such a constraint becomes a constraint imposed between the nodes. In order to search for a solution while satisfying the constraint, for example, state update may be executed between the states satisfying the constraint according to the Markov chain Monte Carlo method. However, it is difficult to solve a large-scale optimization problem within a practical time because it takes time to sequentially process such state updates.

The present invention has been invented in view of such a background, and it is a purpose of the present invention to provide an optimization method, an information processing device, and an information processing system capable of efficiently performing constrained binary quadratic optimization.

### SUMMARY OF THE INVENTION

According to a first aspect of the invention, there is provided an optimization method. Thus, the optimization method is a method using an information processing device that executes a ground state search. The optimization method converts a binary quadratic model with constraints into a complete bipartite graph that has an interaction relationship and a coupling that makes the same values in the ground state between the i-th variable pair of the first variable group and the second variable group. The method, in each variable group, divides the variables into groups that can be updated under satisfying the constraints, and performs state updates for each group in parallel.

According to a second aspect of the invention, there is provided an information processing device. Thus, the information processing device includes an arithmetic unit that updates variables in a variable group of the complete bipartite graph with constraints. The arithmetic unit includes an interaction coefficient memory, a bias coefficient memory, a first variable memory, a second variable memory, and a signal SW supply line. The interaction coefficient memory stores interaction matrix J, which summarizes the interaction coefficients showing the interactions acting between the first variable group and the second variable group, and coupling A that makes the same values in the ground state between the i-th variable pair of the first variable group and the second variable group. The bias coefficient memory stores the bias coefficient h indicating the bias acting on the variable. The first variable memory stores the variables of the first variable group. The second variable memory stores the variables of the second variable group. The signal SW supply line supplies a selection signal SW for selecting the first variable group or the second variable group. And, the arithmetic unit, when the selection signal SW selects the d-th variable group (d=1, 2), calculates the next state for each group of variables summarized by the constraints, the value of the variable read from the memory storing the corresponding variable group, the value of the interaction coefficient in the interaction matrix J corresponding to the variable, the value of the coupling λ, and the value of the bias coefficient h are used as inputs.

According to a third aspect of the invention, there is provided an information processing system. Thus, the information processing system is a system that searches for the ground state. The information processing system includes a user terminal and an arithmetic unit. The user terminal is used for inputting information by the user. The arithmetic unit updates the variables of the variable group of the complete bipartite graph having constraints, and is arranged on a cloud different from the user terminal. The arithmetic unit includes an interaction coefficient memory, a bias coefficient memory, a first variable memory, a second variable memory, and a signal SW supply line. The interaction coefficient memory stores interaction matrix J, which summarizes the interaction coefficients showing the interactions acting between the first variable group and the second variable group, and coupling A that makes the same values in the ground state between the i-th variable pair of the first variable group and the second variable group. The bias coefficient memory stores the bias coefficient h indicating the bias acting on the variable. The first variable memory stores the variables of the first variable group. The second variable memory stores the variables of the second variable group. The signal SW supply line supplies a selection signal SW for selecting the first variable group or the second variable group. And, the arithmetic unit, when the selection signal SW selects the d-th variable group (d=1, 2), calculates the next state for each group of variables summarized by the constraints, the value of the variable read from the memory storing the corresponding variable group, the value of the interaction coefficient in the interaction matrix J corresponding to the variable, the value of the coupling λ, and the value of the bias coefficient h are used as inputs.

### Advantageous Effect

According to the present invention, it is possible to efficiently solve a constrained binary quadratic optimization problem. Purposes, configurations, and effects other than the above will be clarified by the following description of embodiments for performing the invention.

### BRIEF DESCRIPTION OF THE DRAWINGS

FIG. 1 is a conceptual diagram of the energy landscape of BQM.

FIG. 2 is an example of a graph showing the interaction relationship between BQM variables as a complete graph, the solid line shows the interaction relationship between variables, and the broken line shows the group that can be updated so that the constraint condition is satisfied.

FIG. 3 is an example of a graph diagram showing the interaction relationship of variables in BQM as a complete bipartite graph structure.

FIG. 4 is a diagram showing an example of a group capable of updating the state in which the k-hot constraint is satisfied.

FIG. 5 is a diagram showing an example of a group capable of updating the state in which the matrix type constraint is satisfied.

FIG. 6 is an example of the configuration of the information processing device, and is a block diagram showing a schematic configuration of the information processing device.

FIG. 7 is a block diagram showing an example of an arithmetic circuit.

FIG. 8 is an example of the configuration of the information processing device, and is a functional block diagram showing the main functions of the information processing device.

FIG. 9 is a flowchart illustrating an example of the ground state search process.

FIG. 10 is a block diagram showing a detailed configuration example of the arithmetic unit.

FIG. 11 is a block diagram showing a circuit configuration example of one unit.

### DESCRIPTION OF THE PREFERRED EMBODIMENTS

Hereinafter, embodiments will be described in detail with reference to the drawings. In addition, in the following description, the same or similar configurations may be designated by a common reference numeral and duplicated description may be omitted. Further, when there are a plurality of elements having the same or similar functions, different subscripts may be added to the same reference numeral to explain. If it is not necessary to distinguish between multiple elements, the subscript may be omitted and explained.

First, BQM will be described. BQM is defined by a plurality of nodes constituting the model, the interaction relationship between the nodes, and the bias of each node. It is assumed that the variable xᵢ corresponding to each node i (i=1 to N) is x¬ᵢ∈{0,1}. The energy function H (x) (called the Hamiltonian) is defined based on the BQM interaction relationship and bias. An example of this energy function H (x) is shown below.

$$\begin{matrix}Numerical Expression 1 & \\ H ( x ) := - \frac{1}{2} {x}^{T} J x - {h}^{T} x & ( EXPRESSION 1 )\end{matrix}$$

Here, J is a real symmetric matrix with N rows and N columns, and h is an N-dimensional vector. The first term on the right side of expression 1 expresses the interaction relationship, and the second term on the right side expresses the energy function based on the bias. In general, BQM can be expressed as an undirected graph, and the interaction acting between variable pairs in the interaction term is expressed as the edge of the graph. Therefore, Jᵢⱼ in expression 1 does not change the value by the replacement of index. Also, since x²ᵢ=xᵢ, the diagonal element of Jᵢⱼ can be set to 0 by substituting the bias term.

The binary quadratic optimization problem is an optimization problem for finding a variable array {xᵢ} that minimizes the energy function. In this embodiment, the search for the ground state of the interaction model is performed by the Markov Chain Monte Carlo methods (hereinafter referred to as MCMC).

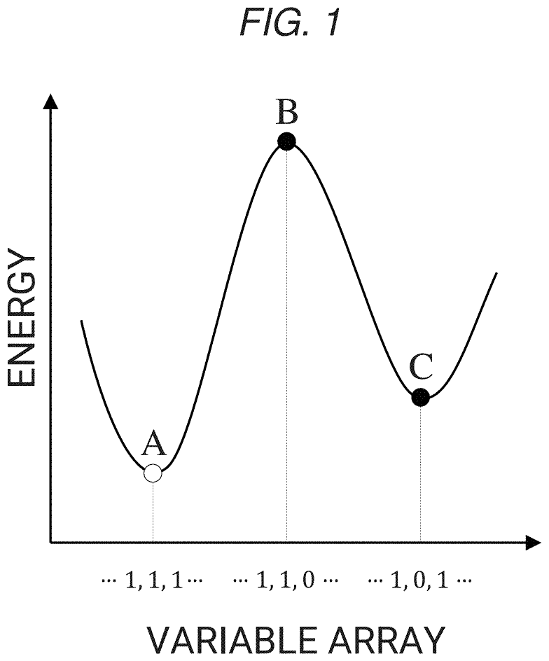

FIG. 1 is a conceptual diagram of the energy landscape of BQM. The horizontal axis of the graph is the variable array, and the vertical axis is the total energy of the system. In MCMC, the probabilistic state update from the current state x={xᵢ} to another state is repeated. As a method for performing such a probabilistic state update, there are a heat bath method and a metropolis method.

In the heat bath method, the state update to the update candidate n is executed with the following probability r, as Eₙ is the energy of the update candidate n, and parameter T for controlling the state update. The following is an example of the formula used in the heat bath method.

NUMERICAL EXPRESSION

r=e^{-E}^{ₙ}^{/T}/Σₙe^{-E}^{ₙ}^{/T} (EXPRESSION 2)

In the metropolis method, the state update to the update candidate is executed with the following probability r, as Δ E is the energy difference between the state of the update candidate and the current state. The following is an example of the formula used in the Metropolis method.

NUMERICAL EXPRESSION 3

r=min{1,exp(−ΔE/T)} (EXPRESSION 3)

When updating the current state x=(x₁, . . . , X_{N}), it is common method to update each variable xᵢ one by one from i=1 to N. By changing the variables one by one, the search is executed for the states that the entire variable can take. For example, in the case of FIG. 1, one 1 of the state A is reversed to 0 and updated to the state B or the state C.

Here, for example, by gradually changing the value of T in expression 2 from a large value to a small value, MCMC is executed while suppressing state update, and the energy gradually converges to the lowest state. Simulated annealing (hereinafter referred to as SA) is a method for finding the optimum solution of a minimization problem using this. Corresponding to the actual annealing, the parameter T is called the temperature parameter.

When MCMC or SA is applied to BQM, the value of the variable is stochastically updated according to the probability based on the energy function of expression 2 or expression 3. Here, the variables having no interaction relation or constraint relation become independent in the energy function, and the state update based on the expression 2 or the expression 3 can be applied at the same time. Therefore, by updating independent variables in parallel, it is possible to speedup the processing of MCMC and SA.

However, as described in Non-Patent Document, many combinatorial optimization problems can be reduced to binary quadratic optimization problems, but they also have constraints that the solution must satisfy. Due to the influence of the constraints, for example, in FIG. 1, the energy of A is the lowest, but considering the constraints to be satisfied, C is the optimum solution. (Here, in FIG. 1, it is assumed that the black dots satisfy the constraint conditions and the white dots do not satisfy the constraint conditions.)

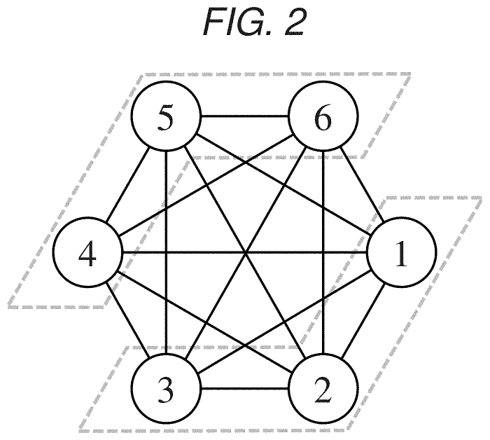

FIG. 2 is a diagram (graph) showing an example of BQM having a constraint relationship between such variables. In the example of FIG. 2, two variable groups having a constraint relationship indicating by a broken line are shown. Further, in a general combinatorial optimization problem, the interaction relationship between variables is generally tightly coupled as shown in FIG. 2. (Individual variables couple with many other variables, as shown by the solid line in FIG. 2). Normally, due to such constraint relationships and interaction relationships, the variables are not independent of each other, and stochastic updates of each variable cannot be executed at the same time, so that it is difficult to speed up the processing of MCMC and SA.

As a means for dealing with the constraint condition, as described in Non-Patent Document 1, the constraint relationship in BQM may be considered to a method using a penalty function method or a Lagrange function (extended Lagrange method, etc.). In these methods, a ground state that satisfies the constraint condition is constructed by adding a penalty function or a Lagrange function corresponding to the constraint condition to the objective function. However, in these methods, the influence of the penalty function etc. is determined by the magnitude of the coefficient, if it is too large, the influence of the original objective function will be small and it will be difficult to find a good solution, and if it is too small, the constraint relationship will not be satisfied, so careful adjustment of the coefficients was necessary. Further, since it is necessary to repeatedly execute SA for adjustment, it is also a problem that the effective processing time increases.

If a plurality of spins can be updated at the same time while satisfying the theoretical background required by MCMC in consideration of the interaction relationship and the constraint relationship, it is possible to speed up the processing of MCMC and SA. In fact, Patent Document 1 proposes a method for efficiently obtaining the ground state by converting the interaction relationship into a complete bipartite graph structure, for BQM (equivalent Ising model) having no constraint condition.

In view of this background, in this embodiment, for a constrained binary quadratic optimization problem, a method of efficiently performing an optimum solution search by SA that executes state updates in parallel while satisfying the constraint relationship without using a penalty function or a Lagrange function will be described.

The constrained binary quadratic optimization problem targeted by the embodiment is a problem of minimizing the BQM of the expression 1 within the range satisfying the following linear equality constraints.

$$\begin{matrix}Numerical Expression 4 & \\ {min}_{x ∈ {\{ 0 , 1 \}}^{N}} H ( x ) subject to Ax = b & ( EXPRESSION 4 )\end{matrix}$$

Here, in expression 4, A is an M×N matrix and b is an M-dimensional vector. Corresponding to expression 4, the following problem is defined.

$$\begin{matrix}Numerical Expression 5 & \\ {min}_{x , y ∈ {\{ 0 , 1 \}}^{N}} \{ H ( x , y ) := - {x}^{⊤} Jy - {h}^{⊤} ( x + y ) + \frac{λ}{2} {‖ x - y ‖}^{2} \} & ( EXPRESSION 5 )\end{matrix}$$

$$subject to Ax = b , Ay = b$$

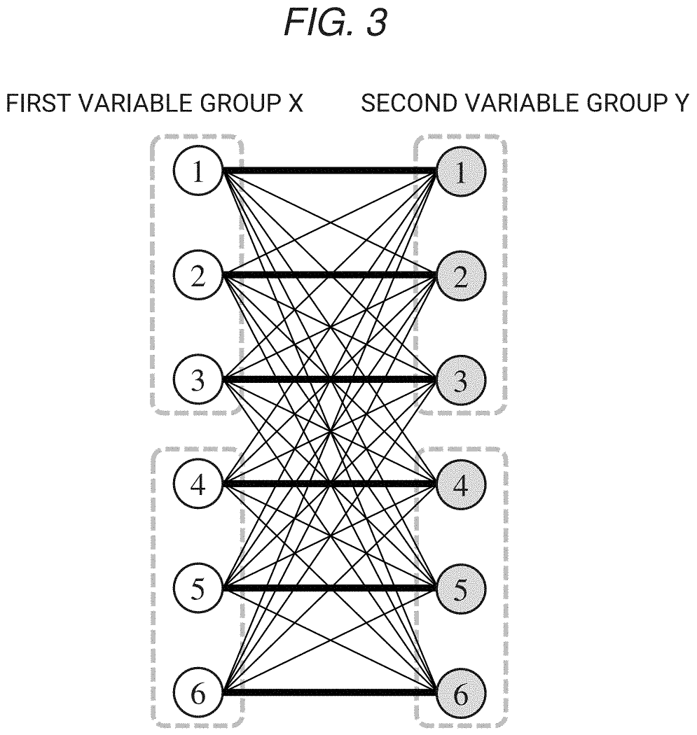

FIG. 3 is a graph showing H (x, y) of expression 5, and the interaction relationship of expression 5 is a complete bipartite graph structure. That is, FIG. 3 is a structure in which a binary quadratic model is converted into a complete bipartite graph. Here, the groups of the variable groups x and y shown by the broken lines correspond to the groups in FIG. 2. In addition, the two variable groups are called the first variable group x and the second variable group y, respectively. An interaction of magnitude Jᵢⱼ acts between xᵢ of the first variable group and yⱼ of the second variable group.

The third term on the right side of expression 5 acts as an interaction such that the values of the i-th (i=1 to N) pairs of the first and second variable groups are aligned. When the coupling λ>0 is set to a sufficiently large value, the optimum solution of expression 5 exists in the range of x=y, therefor, this is consistent with the optimal solution of expression 4, which is the original problem. In fact, it is possible to show sufficient conditions for the coupling A for the optimum solutions of expressions 4 and 5 to match. One of them is that the following expression 6 holds for any μ>0.

NUMERICAL EXPRESSION 6

λ>−λₘᵢₙ(J+μA^{T}(I−b⊗b^{T}/∥b∥²)A) (EXPRESSION 6)

Here, in expression 6, λₘᵢₙ (W) indicates the minimum eigenvalue of the real symmetric matrix W.

Here, the solution search of the expression 4 can be executed by setting an appropriate coupling λ and performing the solution search of the expression 5. Since expression 5 has the interaction relationship of the complete bipartite graph structure shown in FIG. 3, there is no interaction relationship between different variables inside the variable group. Therefore, if the variable group x (y) is divided into updateable groups that satisfy the constraint conditions and updated, it is possible to update all at once while satisfying the constraint relationship of the variable group x (y). That is, the processing efficiency of SA can be improved by parallel processing. Therefore, in the embodiment, the original problem, expression 4, is solved by solving expression 5 based on SA.

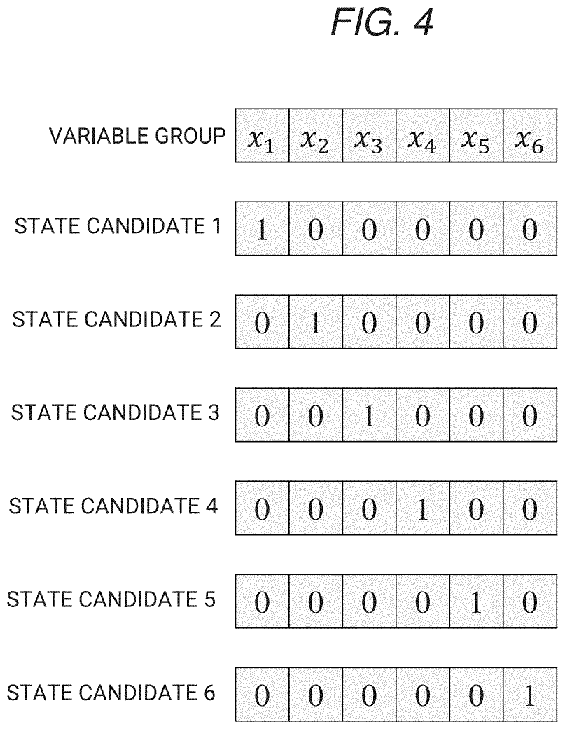

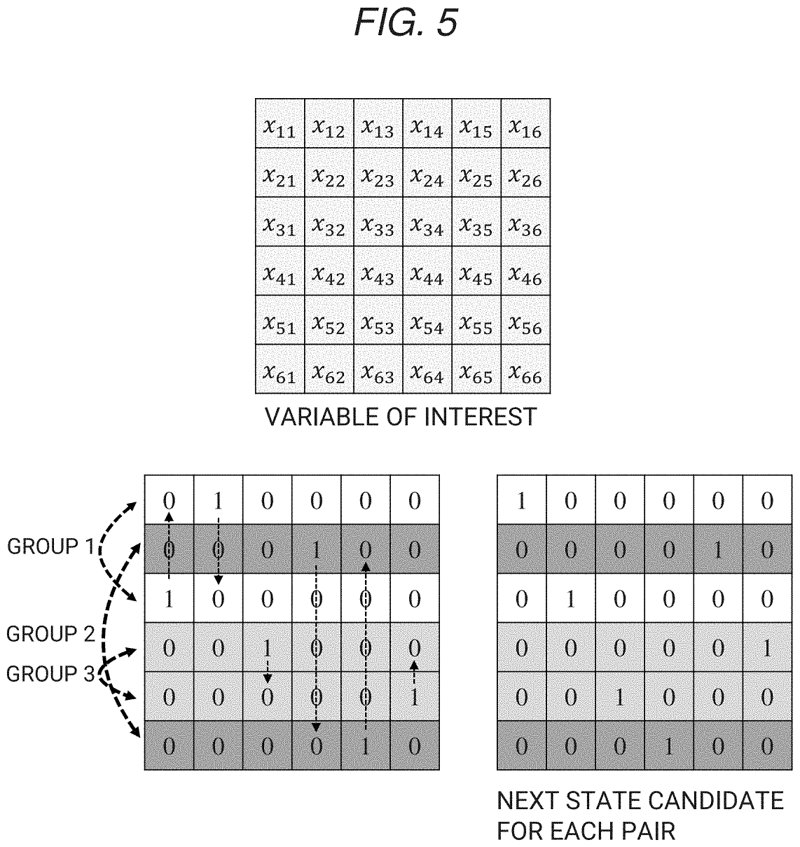

The update that satisfies the constraint relations shown in FIGS. 4 and 5 depends on the constraint conditions. Therefore, in this embodiment, an example of such an update method is shown for the k-hot constraint and the matrix type constraint that often appear in the combinatorial optimization problem.

The k-hot constraint is a constraint that imposes that k variables take 1 and other variables take 0 in the variable group. When the number of variables included in the variable group ism, this constraint condition is expressed by expression 7.

NUMERICAL EXPRESSION 7

Σᵢ₌₁^{m}xᵢ=k EXPRESSION 7

There are ₘ Cₖ state candidates that satisfy this constraint. For example, FIG. 4 shows a state candidate when k=1 and m=6. As an example, in order to perform a state update satisfying the constraint condition for such a k-hot constraint, the energy may be calculated for each state candidate and the state candidate may be selected based on the probability of expression 2.

The matrix type constraint imposes a 1-hot constraint on each of the indexes i and j of the variable xᵢⱼ. This constraint is expressed by expression 8.

NUMERICAL EXPRESSION 8

∀i,Σⱼxᵢⱼ=1 and ∀j,Σⱼxᵢⱼ=1 (EXPRESSION 8)

FIG. 5 shows the case of i and j=1 to 6 as an example. To perform the state update while satisfying the constraint, for example, it is conceivable to divide the group into the groups (pairs of two rows) shown in FIG. 5 (that is, as shown in FIG. 5, a pair that can be updated in a state that satisfies the matrix type constraint is constructed.), and replace the columns having 1 element. Here, as an example, whether or not to carry out this update may be stochastically determined based on expression 3.

Here, an example of a variable group that can be updated with the constraints satisfied for the k-hot constraint and the matrix type constraint and the update method thereof is shown. However, other update methods can be adopted as long as they meet the requirements of MCMC. Also, for other constraints, the same procedure can be applied by dividing them into variable groups in the same way.

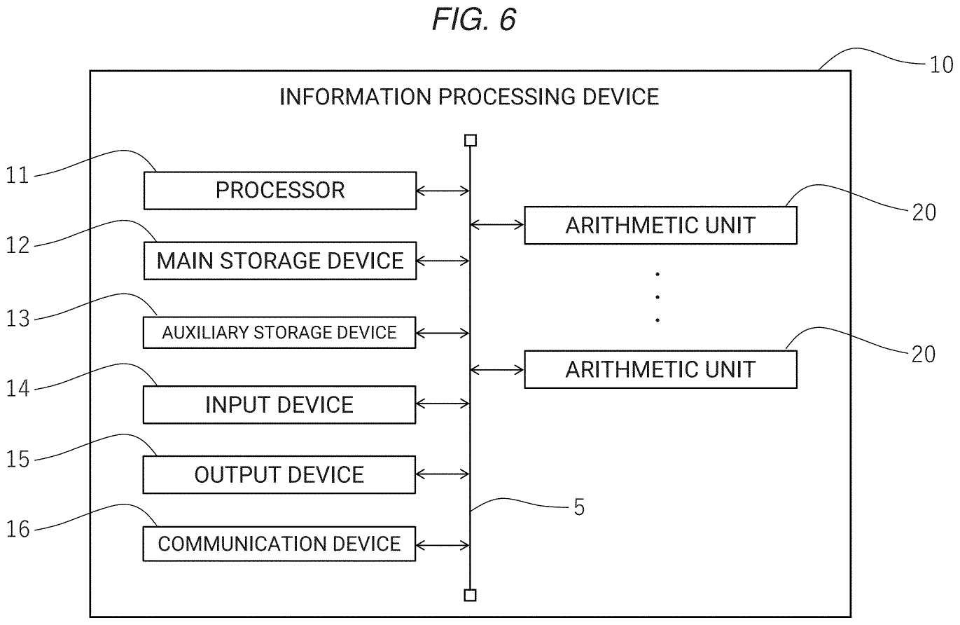

Subsequently, an embodiment of an information processing device that executes state updates in parallel while satisfying the above-mentioned constraint relations will be shown. The information processing device 10 shown in FIG. 6 includes a processor 11, a main storage device 12, an auxiliary storage device 13, an input device 14, and an output device 15, a communication device 16, one or more arithmetic units 20, and a system bus 5 for communicably connecting these devices. For example, the information processing device 10 may be partially or wholly realized by using a virtual information processing resource such as a cloud server provided by a cloud system. As an example, the part that executes the update process and the part that is used to store the data in the update process are placed on the cloud, and the process may be executed based on the information input via the input device on the user terminal side. Further, the information processing device 10 may be realized by, for example, a plurality of information processing devices that are communicably connected and operate in cooperation with each other.

The processor 11 is configured by using, for example, a CPU (Central Processing Unit) or an MPU (Micro Processing Unit). The main storage device 12 is a device that stores programs and data, and is, for example, ROM (Read Only Memory), SRAM (Static Random Access Memory), NVRAM (Non Volatile RAM) mask ROM (Mask Read Only Memory), PROM (Programmable ROM), etc., RAM (Random Access Memory), DRAM (Dynamic Random Access Memory), and the like. The auxiliary storage device 13 is a hard disk drive (Hard Disk Drive), a flash memory (Flash Memory), an SSD (Solid State Drive), an optical storage device (CD (Compact Disc), DVD (Digital Versatile Disc)), or the like. The programs and data stored in the auxiliary storage device 13 are read into the main storage device 12 at any time.

The input device 14 is a user interface that receives information input from the user, and is, for example, a keyboard, a mouse, a card reader, a touch panel, or the like. The output device 15 is a user interface that provides information to the user, and is, for example, a display device (LCD (Liquid Crystal Display)) or the like that visualizes various information, an audio output device (speaker), a printing device, or the like. Further, regarding the display, for example, a graphic card may be provided. The communication device 16 is a communication interface for communicating with other devices, and is, for example, an NIC (Network Interface Card), a wireless communication module, a USB (Universal Serial Interface) module, a serial communication module, and the like.

The arithmetic unit 20 is a device that executes a ground state search. The arithmetic unit 20 may take the form of an expansion card to be mounted on the information processing unit 10, such as a GPU (Graphics Processing Unit). The arithmetic unit 20 is composed of hardware such as, for example, a CMOS (Complementary Metal Oxide Semiconductor) circuit, an FPGA (Field Programmable Gate Array), an ASIC (Application Specific Integrated Circuit), or the like. The arithmetic unit 20 includes a control device, a storage device, an interface for connecting to the system bus 5, and sends/receives commands and information to/from the processor 11 via the system bus 5. The arithmetic unit 20 may be connected to the other arithmetic unit 20 so as to be communicable via a communication line, and may operate in cooperation with the other arithmetic unit 20. The function realized by the arithmetic unit 20 may be realized, for example, by causing a processor (CPU, GPU, etc.) to execute a program.

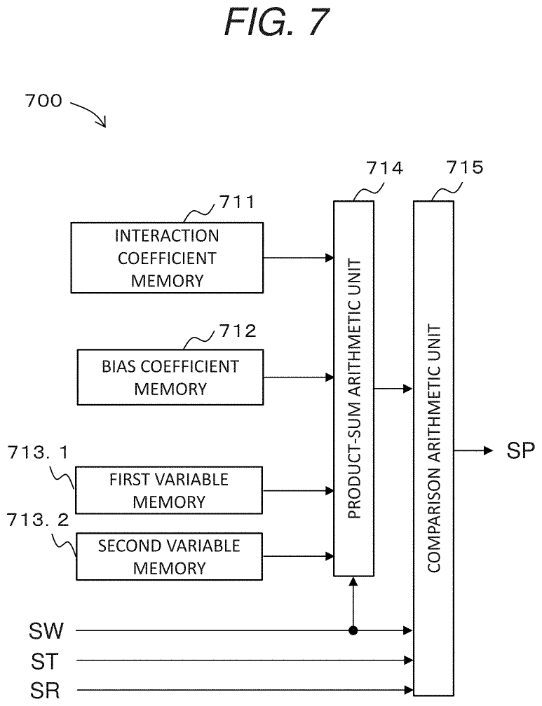

FIG. 7 is a diagram for explaining the operating principle of the arithmetic unit 20, and is a block diagram of a circuit (hereinafter, referred to as an arithmetic circuit 700) constituting the arithmetic unit 20. The arithmetic circuit 700 realizes the calculation of the energy function based on the expression 5 and the stochastic state update process based on the expressions 2 and 3. Hereinafter, the operating principle of the arithmetic unit 20 will be described with reference to the figure.

As shown in the figure, the arithmetic circuit 700 includes an interaction coefficient memory 711, a bias coefficient memory 712, a d-variable memory 713.d (d=1,2), a product-sum arithmetic unit 714, and a comparison arithmetic unit 715.

The interaction coefficient memory 711 stores information representing the interaction matrix J and the coupling λ. As described above, since the interaction matrix is a real symmetric matrix, the amount of memory 711 used can be reduced by using this symmetry.

The bias coefficient memory 712 stores information on the vector h that defines the bias term.

The d-variable memory 713.d (d=1,2) stores information of an N-dimensional vector indicating the state of the d-variable group of the complete bipartite graph structure described above.

Signals SW, SR, and ST are input to the arithmetic circuit 700. The mathematical function arithmetic unit (comparison arithmetic unit 715 in FIG. 7) outputs a signal SP.

The signal SW is a signal that periodically repeats integers 1 and 2, and specifies a variable memory 713.d (d=1,2) to be updated. The signal SW is supplied via the signal SW supply line of the arithmetic unit 20.

The signal ST inputs the temperature parameter T in the expression 2 and the expression 3. The signal ST is supplied via the signal ST supply line of the arithmetic unit 20.

The signal SR is a signal that gives a uniform random number of 0 to 1. It is used to determine the update in expression 2 and expression 3. The signal SR is supplied via the signal SR supply line of the arithmetic unit 20.

As described above, the coupling λ is set as a sufficiently large value based on the interaction matrix J, the matrix A that defines the constraint conditions, and the vector b. The numerical evaluation based on the expression 6 may be performed outside the arithmetic unit 20, for example, the processor 11. In addition, calculation can be performed in the arithmetic unit 20. For example, when the maximum eigenvalue is calculated by the exponentiation method or the like, this calculation repeatedly executes a matrix-vector product, and the product-sum arithmetic unit 714 can be utilized.

Data from the interaction coefficient memory 711, the bias coefficient memory 712, the d-variable memory 713.d (d=1,2), and the signal SW are input to the product-sum arithmetic unit 714. The energy for updating the state of the d-variable group is calculated and output by performing the product-sum operation of expression 5.

In expressions 2 and 3, probabilistic processing based on the energy value is required, and the comparison arithmetic unit 715 executes this portion. The variable group to be updated is specified by the signal SW. Further, the temperature parameter T included in the expression 2 and the expression 3 is input from the signal ST. Based on the value of the uniform random number input from the signal SR, the selection of the next state in the expression 2 or the acceptance/rejection of the next state in the expression 3 is determined. The value of the variable, which is the output value, is output to the signal SP.

The arithmetic of the arithmetic circuit 700 can be executed independently, for each group that can execute state update that satisfies the constraint conditions as shown in FIG. 3. That is, the speed of MCMC and SA can be increased by executing a plurality of arithmetic circuits 700 in parallel.

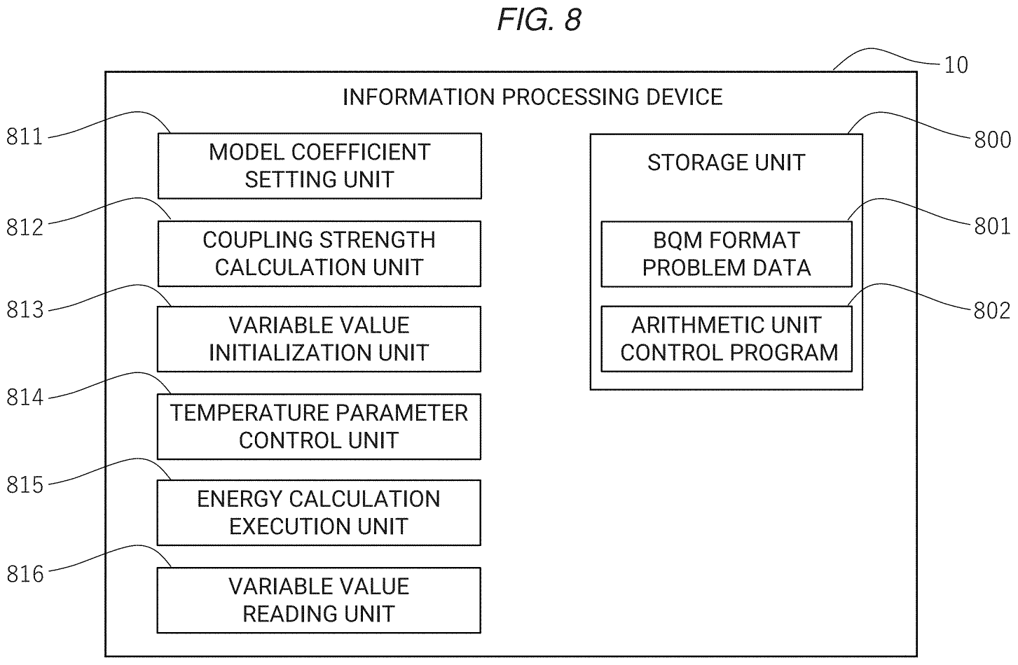

FIG. 8 shows the main functions (software configuration) included in the information processing device 10. As shown in the figure, the information processing device 10 includes a storage unit 800, an interaction coefficient setting unit (model coefficient setting unit 811 in the figure), and a coupling strength calculation unit 812, a variable value initialization unit 813, a temperature parameter control unit 814, an interaction calculation execution unit (energy calculation execution unit 815 in the figure), and a variable value reading unit 816. These functions are realized by the processor 11 reading and executing the program stored in the main storage device 12, or by the hardware provided in the arithmetic unit 20. In addition to the above functions, the information processing device 10 may have other functions such as an operating system, a file system, a device driver, and a DBMS (Database Management System).

Among the above functions, the storage unit 800 stores the BQM format problem data 801 and the arithmetic unit control program 802 in the main storage device 12 or the auxiliary storage device 13. The BQM format problem data 801 is data in which a combinatorial optimization problem is input in a predetermined description format. That is, it is related to the data of the interaction matrix J of the expression 4 which is the problem to be solved, the vector h of the bias coefficient, and the matrices A and the vector b which define the constraint conditions. The BQM format problem data 801 is set by the user, for example, via a user interface (input device, output device, communication device, etc.). The arithmetic unit control program 802 is a program that is executed when the energy arithmetic execution unit 815 controls the arithmetic unit 20, or is a program that loads the energy arithmetic execution unit 815 into individual arithmetic units 20 and causes the arithmetic unit 20 to execute processing.

The model coefficient setting unit 811 sets the interaction matrix J in the interaction coefficient memory 711 and the vector h in the bias coefficient memory 712 based on the BQM format problem data 801.

The coupling strength calculation unit 812 calculates the value of the coupling Ain the expression 5 from the BQM format problem data 801 based on the expression 6 and sets it in the interaction coefficient memory 711.

The variable value initialization unit 813 initializes the value stored in the variable memory 713.d (d=1,2) of the arithmetic unit 20 to an appropriate value satisfying the constraint condition.

The temperature parameter control unit 814 controls the temperature parameter T in the expressions 2 and 3.

The interaction calculation execution unit (energy calculation execution unit 815) performs a ground state search by SA using the value of the energy function according to expressions 2 and 3.

The variable value reading unit 816 reads the value stored in the variable memory 713.d (d=1,2) when SA is executed by the energy calculation executing unit 815. Then, the variable value reading unit 816 ends the ground state search by outputting the read value to the output device 15 and the communication device 16.

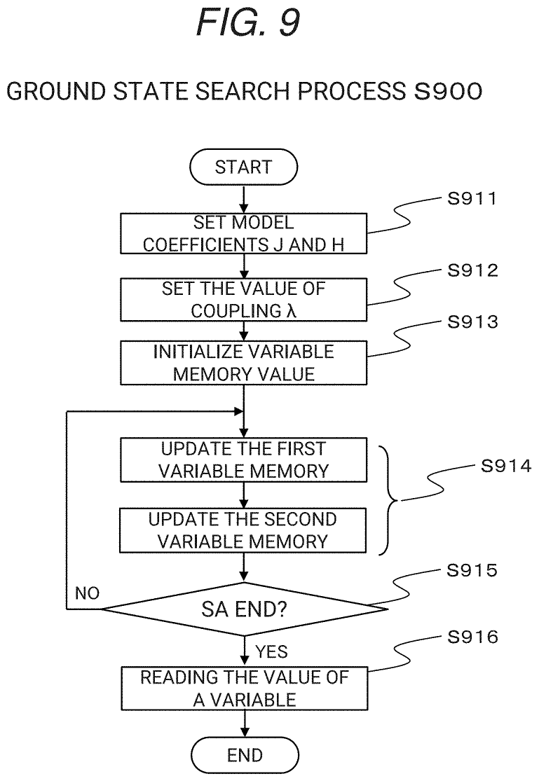

FIG. 9 is a flowchart illustrating a process (hereinafter referred to as a ground state search process S900) performed by the information processing device 10 when searching for the ground state of BQM. Hereinafter, the ground state search process S900 will be described with reference to the figure. In the following description, the letter “S” attached before the numeral means a processing step. The ground state search process S900 is started by receiving an instruction or the like from the user via the input device 14, for example.

First, the model coefficient setting unit 811 sets values in the interaction coefficient memory 711 and the bias coefficient memory 712 from the BQM format problem data 801 of the storage unit 800 (S911). Note that, the user can also set or edit the value of the memory via the user interface (for example, realized by the input device 14, the output device 15, the communication device 16, etc.).

Subsequently, the coupling strength calculation unit 812 sets the coupling λ from the expression 6 based on the values of the interaction matrix J stored in the BQM format problem data 801 of the storage unit 800, the matrix A defining the constraint conditions, and the vector b, and stores the coupling λ in the interaction coefficient memory 711. As described above, this calculation may be performed in the arithmetic unit 20 or in the processor 11 (S912).

Subsequently, the variable value initialization unit 813 initializes the value stored in the variable memory 713.d (d=1,2) (S913).

Subsequently, the energy calculation execution unit 815 updates the value of the variable memory 713.d (d=1,2) by executing the SA based on the value of the energy function according to the expressions 2 and 3 (S914).

Subsequently, the energy calculation execution unit 815 (interaction calculation execution unit) determines whether or not the SA end condition is satisfied (for example, whether or not the state update is executed while changing the temperature parameter T a predetermined number of times) (S915). When the interaction calculation execution unit 815 determines that the SA end condition is satisfied (S915: YES), the process proceeds to S916. On the other hand, when the interaction calculation execution unit 815 determines that the stop condition is not satisfied (S915: NO), the process returns to S914.

Subsequently, the variable value reading unit 817 reads the value stored in the variable memory 713.d (d=1,2) and stores it as the result of the ground state search (S916), and the ground state search process S900 ends.

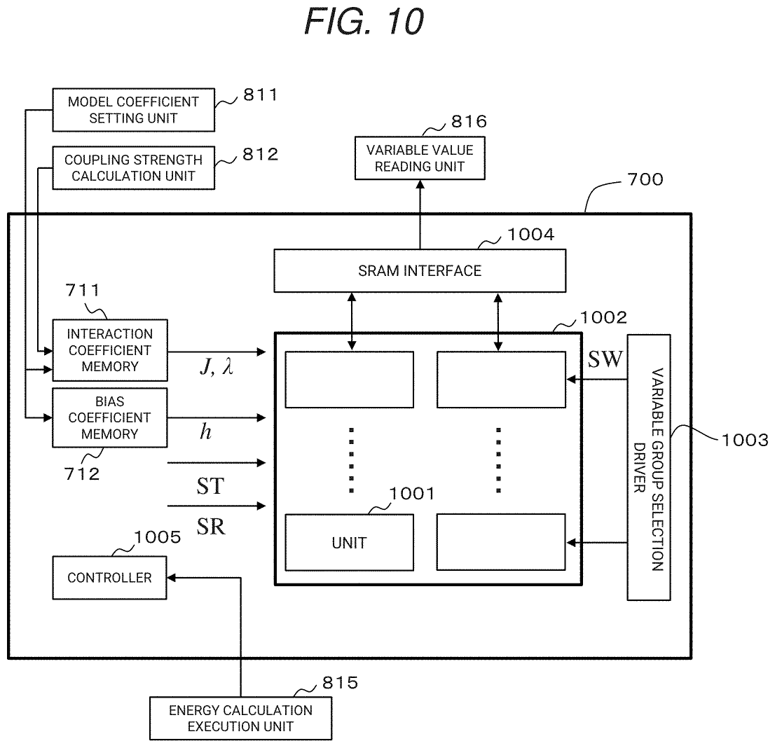

FIG. 10 is a block diagram showing a detailed configuration example of the arithmetic unit 20, and is a block diagram showing a circuit configuration example when the SRAM technique is applied to the arithmetic circuit 700 of the present embodiment. In this configuration example, a plurality of units 1001 constitute an array unit 1002. Such a configuration can be manufactured by applying semiconductor manufacturing technology.

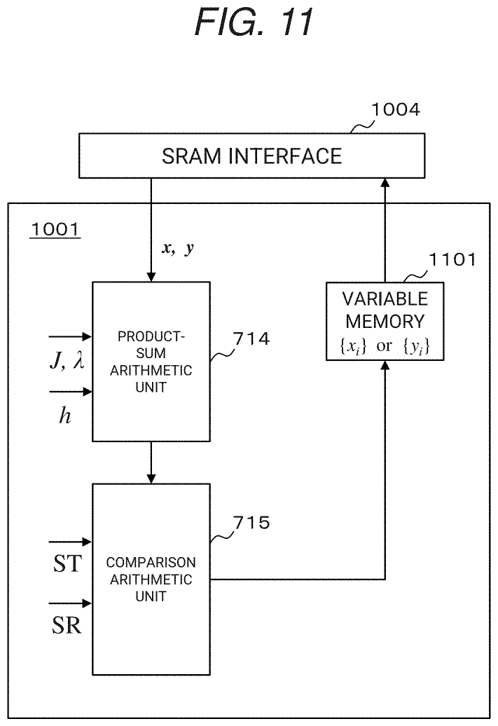

FIG. 11 is an example of a circuit configuration of one unit 1001. One unit 1001 includes a variable memory 1101 for storing one variable group and a configuration for updating the value of the variable memory 1101 described later. That is, as many units 1001 are prepared as the number of groups shown by the broken line in FIG. 3, and in the case of the example of FIG. 3, four units 1001 are prepared for each constraint.

An example of the configuration of FIG. 10 will be described with reference to the generalized configuration of FIG. 7. The data stored in the interaction coefficient memory 711 and the bias coefficient memory 712 are set by the model coefficient setting unit 811 and the coupling strength calculation unit 812. The value of the interaction matrix J and the coupling λ is stored in the interaction coefficient memory 711, and the value of the vector h is stored in the bias coefficient memory 712, but they are commonly used in all the units 1001 in order to reduce the circuit scale. Therefore, the interaction coefficient memory 711 and the bias coefficient memory 712 supply the coefficients J, h, and A to all the units 1001 (that is, supply to all the units 1001 with the value of the interaction coefficient used for processing in the interaction matrix J, the value of the bias used for the processing, and the value of the coupling λ used for the processing), but the signal lines for that purpose are omitted in FIG. 10. Note that, FIG. 10 is an example, and in principle, each unit 1001 may be provided with an interaction coefficient memory 711 and a bias coefficient memory 712.

As described with reference to FIG. 3, the variable group selection driver 1003 selects one group from the first and second variable groups, and inputs a signal SW for permitting update to each unit 1001. Therefore, only one specific variable group is updated.

The SRAM interface 1004 has a configuration described later, and writes to and reads from the variable memory 1101 that stores the variables of the unit 1001 created by applying the circuit configuration of the SRAM. The value of the variable read after the processing in the arithmetic circuit 700 is completed is sent to the variable value reading unit 816. The variable value reading unit 816 outputs the result of the ground state search by appropriately storing and outputting the read value.

The controller 1005 initializes the arithmetic circuit 700 and inform the end of processing according to the instruction of the energy arithmetic execution unit 815.

FIG. 11 is a diagram showing a circuit configuration example of one unit 1001. One unit includes a variable memory 1101 that stores any one of the variable groups obtained by further dividing the two variable groups. Here, the variable group is a group of variables that can be updated while satisfying the constraints as shown in FIGS. 4 and 5. In this example (example of FIG. 3), one variable memory 1101 of one unit 1001 stores one variable group having a common constraint condition in the first variable group as the first variable memory or stores one variable group having a common constraint condition in the second variable group as the second variable memory.

The value of the current variable is input to the product-sum arithmetic unit 714. These variables are generated by the SRAM interface 1004 reading from the variable memory 1101 of the other unit 1001. Further, the values stored in the interaction coefficient memory 711 and the bias coefficient memory 712 are input.

The output of the product-sum arithmetic unit 714, the signal ST, and the signal SR are input to the comparison arithmetic unit 715. Then, the next state of the variable group is output based on the expressions 2 and 3, and stored in the variable memory 1101.

As described in detail above, according to the information processing device 10 of the present embodiment, it is possible to efficiently search for the ground state of the constrained BQM, by dividing the variables into groups that can update the state that satisfies the constraints and parallelizing the updates of each group. Further, as described above, the ground state search based on SA can be efficiently executed. Since the information processing device 10 (including the arithmetic unit 20) has a simple structure, it can be manufactured inexpensively and easily. The information processing device 10 can be used in various fields, and as an example, it is also possible to contribute to economic efficiency and energy saving by finding the optimum solution of the objective function set from the viewpoint of economic efficiency and energy saving.

Although one embodiment has been described in detail above, it is needless to say that the present invention is not limited to the above embodiment and can be variously modified without departing from the gist thereof. For example, the above-described embodiment has been described in detail in order to explain the present invention in an easy-to-understand manner, and is not necessarily limited to the including all the described configurations. Further, it is possible to add/delete/replace another configuration to a part of the configuration of the above embodiment.

Further, with respect to each of the above configurations, functional units, processing units, processing means and the like, some or all of them may be realized by hardware, for example, by designing with an integrated circuit. Further, each of the above configurations, functions, and the like may be realized by software by the processor interpreting and executing a program that realizes each function. Data such as programs, tables, and files that realize each function can be placed in a memory, a hard disk, a recording device such as an SSD (Solid State Drive), or a recording medium such as an IC card, a SD card, or a DVD.

Further, in each of the above figures, the control lines and data lines are shown as necessary for explanation, and do not necessarily show all the control lines and data lines in the implementation. For example, in practice, it may be considered that almost all configurations are interconnected.

Further, regarding the information processing device 10 described above, the various functional units, the various processing units, and the arrangement form of the various databases are only an example. The various functional units, the various processing units, and the arrangement form of the various databases can be changed to the optimum arrangement form from the viewpoint of the performance, processing efficiency, communication efficiency, and the like of the hardware and software included in the information processing device 10.

Further, the configuration of the database (schema etc.) for storing various data described above can be flexibly changed from the viewpoints of efficient use of resources, improvement of processing efficiency, improvement of access efficiency, improvement of search efficiency, and the like.

As described above, the part of the information processing device 10 having an arithmetic function may be arranged on the cloud, and an information processing system including a user terminal having a user interface function such as an input device and an arithmetic unit 20 arranged on the cloud may be provided. In this information processing system, the arithmetic unit 20 is configured to be able to communicate with the outside such as a user terminal via an appropriate interface. Then, the user can set or edit the BQM format problem data 801 (that is, values related to the interaction coefficient, bias, etc., constraints, etc.) via the user terminal. Further, the data and the processing result used in the processing of the arithmetic unit 20 may be stored in the arithmetic unit 20 or may be stored outside the arithmetic unit 20.

It can be used for optimization methods, information processing devices, and information processing systems.

What is claimed is:

1. An optimization method using an information processing device that executes a ground state search, comprising:
converting a binary quadratic model with constraints into a complete bipartite graph that has an interaction relationship and a coupling that makes the same values in the ground state between the i-th variable pair of the first variable group and the second variable group,
in each variable group, dividing the variables into groups that can be updated under satisfying the constraints, and performing state updates for each group in parallel.

2. An optimization method according to claim 1, wherein
the information processing device includes a first variable memory that stores the value of the 0/1 variable of the first variable group, a second variable memory that stores the value of the 0/1 variable of the second variable group, and a signal SW supply line that supplies a selection signal SW that selects one of the variable groups when updating the value, and updates the state of the variable of the memory selected by the selection signal SW according to an update method that satisfies the constraint imposed on the variable.

3. An optimization method according to claim 2, wherein
the information processing device searches for the ground state by performing an operation based on simulated annealing,
the information processing device includes an interaction coefficient memory that stores an interaction matrix J that defines the interaction relationship of the binary quadratic model and a coupling strength A that is a value related to the coupling, a bias coefficient memory that stores the vector h related to the bias of the variable, a signal ST supply line that supplies the temperature signal ST related to the temperature parameter T, and a signal SR supply line that supplies a random number signal SR that gives a uniform random number from 0 to 1, and calculates the next state based on the interaction matrix J, the coupling strength A, the vector h, the temperature signal ST, and the random number signal SR.

4. An optimization method according to claim 3, wherein
the interaction matrix J is a real symmetric matrix, and the coupling strength A can be determined by numerical calculation based on the interaction matrix J and the constraints.

5. An optimization method according to claim 3, wherein
the state is updated based on the hot bath method or the metropolis method.

6. An information processing device that searches the ground state, comprising:
an arithmetic unit that updates variables in a variable group of the complete bipartite graph with constraints, and
the arithmetic unit includes
an interaction coefficient memory that stores interaction matrix J, which summarizes the interaction coefficients showing the interactions acting between the first variable group and the second variable group, and coupling λ that makes the same values in the ground state between the i-th variable pair of the first variable group and the second variable group,
a bias coefficient memory that stores the bias coefficient h indicating the bias acting on the variable,
a first variable memory that stores the variables of the first variable group,
a second variable memory that stores the variables of the second variable group, and
a signal SW supply line that supplies a selection signal SW for selecting the first variable group or the second variable group,
the arithmetic unit, when the selection signal SW selects the d-th variable group (d=1, 2), calculates the next state for each group of variables summarized by the constraints, the value of the variable read from the memory storing the corresponding variable group, the value of the interaction coefficient in the interaction matrix J corresponding to the variable, the value of the coupling λ, and the value of the bias coefficient h are used as inputs.

7. An information processing device according to claim 6, wherein
the arithmetic unit includes a unit that executes variable update processing, and a plurality of the units are provided, one for each constraint, and the first variable memory or the second variable memory is arranged in each of the plurality of units, and the first variable memory and the second variable memory store a group of variables summarized by constraints.

8. An information processing device according to claim 6, wherein
the arithmetic unit includes a product-sum arithmetic unit that executes the calculation of the next state based on the product-sum operation.

9. An information processing device according to claim 6, wherein
the arithmetic unit includes a comparison arithmetic unit that operates the next state of the update destination by executing a probabilistic update.

10. An information processing device according to claim 9, wherein
the arithmetic unit includes a signal ST supply line for supplying a temperature signal ST relating to a temperature parameter T, and a signal SR supply line for supplying a random number signal SR that gives a uniform random number of 0 to 1,
the comparison arithmetic unit performs an operation based on simulated annealing by using the output value by the calculation, the temperature signal ST, and the random number signal SR as input values, and outputs the next state of the variable group as an output value.

11. An information processing system that searches the ground state, comprising:
a user terminal used for inputting information by the user, and
an arithmetic unit that updates variables in a variable group of the complete bipartite graph with constraints, and is placed on a cloud different from the user terminal,
the arithmetic unit includes
an interaction coefficient memory that stores interaction matrix J, which summarizes the interaction coefficients showing the interactions acting between the first variable group and the second variable group, and coupling λ that makes the same values in the ground state between the i-th variable pair of the first variable group and the second variable group,
a bias coefficient memory that stores the bias coefficient h indicating the bias acting on the variable,
a first variable memory that stores the variables of the first variable group,
a second variable memory that stores the variables of the second variable group, and
a signal SW supply line that supplies a selection signal SW for selecting the first variable group or the second variable group,
the arithmetic unit, when the selection signal SW selects the d-th variable group (d=1, 2), calculates the next state for each group of variables summarized by the constraints, the value of the variable read from the memory storing the corresponding variable group, the value of the interaction coefficient in the interaction matrix J corresponding to the variable, the value of the coupling λ, and the value of the bias coefficient h are used as inputs.

12. An information processing system according to claim 11, wherein
the arithmetic unit includes a unit that executes variable update processing, and a plurality of the units are provided, one for each constraint, and the first variable memory or the second variable memory is arranged in each of the plurality of units, and the first variable memory and the second variable memory store a group of variables summarized by constraints.

13. An information processing system according to claim 11, wherein
the arithmetic unit includes a comparison arithmetic unit that operates the next state of the update destination by executing a probabilistic update.

14. An information processing system according to claim 13, wherein
the arithmetic unit includes a signal ST supply line for supplying a temperature signal ST relating to a temperature parameter T, and a signal SR supply line for supplying a random number signal SR that gives a uniform random number of 0 to 1,
the comparison arithmetic unit performs an operation based on simulated annealing by using the output value by the calculation, the temperature signal ST, and the random number signal SR as input values, and outputs the next state of the variable group as an output value.

15. An information processing system according to claim 11, wherein
the user can set the data related to the problem to be solved via the user terminal.
